(19) United States
(12) Patent Application Publication
(10) Pub. No.: US 2015/0022655 A1
(43) Pub. Date: Jan. 22, 2015

(54) APPARATUS AND METHOD USING A LINEAR ARRAY OF OPTICAL SENSORS FOR IMAGING A ROTATING COMPONENT OF A GAS TURBINE ENGINE

(71) Applicant: Forrest R. Ruhge, Orlando, FL (US)

(72) Inventor: Forrest R. Ruhge, Orlando, FL (US)

(21) Appl. No.: 13/946,158

(22) Filed: Jul. 19, 2013

(51) Int. Cl. H04N 5/238; H04N 5/335; H04N 9/04

(52) U.S. Cl. CPC H04N 5/238; H04N 9/04; H04N 5/335; H04N 2005/2255
USPC 348/82

(57) ABSTRACT

Apparatus and method using a linear array (22) of optical sensors (24) for imaging a rotating component (12) of a gas turbine engine. A viewing probe (16) may include the linear array of optical sensors disposed in the probe to acquire image data that may be made up of a series of line scans capturing views of the component passing within a field of view of the probe. A controller (26) may be electrically coupled to the linear array to process the series of line scans to generate an image of the component.

### FIELD OF THE INVENTION

Aspects of the invention are related to gas turbine engines, and, more particularly, to apparatus and method using optical sensors for imaging components of the gas turbine engine.

### BACKGROUND OF THE INVENTION

Inaccessible or confined areas, such as the interior of gas turbine engines, often require inspection to verify the integrity of internal engine components (e.g., rotating blades) and maintain safe operation of the engine by proactively identifying potential issues, e.g., identifying incipient defects in a component prior to an occurrence of a component failure. Some of these issues may be identified through visual inspection by use of a borescope, such as may be performed during routine maintenance of the gas turbine engine.

Certain known borescopes may involve relatively long optical paths, which generally require a relatively large number of optical elements (e.g., a series of relaying lenses for conveying images obtained in the interior of the engine to a camera location outside the engine), and consequently this type of optical arrangement may lead to optical attenuation and thus the resulting imaging capability may have somewhat limited resolution.

Accordingly, at least in view of the foregoing considerations, there continues to be a need for improved apparatus and/or techniques as may be useful to generate images of rotating components in a gas turbine engine.

### BRIEF DESCRIPTION OF THE DRAWINGS

The invention is explained in the following description in view of the drawings that show:

FIG. 1 is a schematic representation of one non-limiting embodiment of an apparatus including a viewing probe having a linear array of optical sensors disposed in the probe, and which may be used for imaging rotating components in a gas turbine engine.

FIG. 2 shows a schematic of one non-limiting embodiment of the linear array of optical sensors.

FIG. 3 shows a schematic of one non-limiting embodiment of a multi-linear array of optical sensors, as may be used for generating a color image of the component.

FIG. 4 shows a schematic of one non-limiting embodiment, where a lens may be optically coupled to the linear array of optical sensors.

FIG. 5 shows a schematic of one non-limiting embodiment, where an array of microlenses may be optically coupled to the linear array of optical sensors.

FIG. 6 is a plot of an example waveform generated by an array of optical sensors in response to passing blades.

### DETAILED DESCRIPTION OF THE INVENTION

FIG. 1 illustrates an embodiment of an apparatus 10 as may be used for imaging one or more rotating components 12 (e.g., rotating blades) in a gas turbine engine 14. Apparatus 10 may include a viewing probe 16, which in one non-limiting application may extend between a radially outer casing wall 18 and an inner casing wall 20 of turbine engine 14. A linear array 22 of optical sensors 24 (FIG. 2) is disposed in the probe (e.g., proximate a distal end 23 of probe 16) to acquire image data made up of a series of line scans capturing views of rotating component 12, as the rotating component passes within a field of view 17 of the probe.

Non-limiting examples of optical sensors 24 (FIG. 2), which may be utilized in linear array 22 may be charge coupling device (CCD) sensors and complementary metal oxide semiconductor (CMOS) sensors. A controller 26 is electrically coupled to linear array 22 to process the series of line scans to generate an image of component 12. Linear array 22 may include appropriate signal conditioning circuitry, such as analog-to-digital conversion, etc.

It will be appreciated that opposite to known traditional approaches—which may involve optical signals passing through a series of lenses inside the viewing probe, and which thus may introduce substantial optical attenuation, as such optical signals pass there through to be eventually conveyed to a camera outside the probe—aspects of the present invention allow conveying imaging data by way of an interface 25 in the form of electrical signals from linear array 22 and thus the signals processed by controller 26 do not suffer from the optical attenuation issues encountered by such traditional approaches. Motion control signals, as may be used to register position coordinates and provide automated motion control of probe 16 (symbolically represented by arrows 31) may be conveyed by way of an interface 27.

In one application, the acquisition of image data of the rotating components may be performed during a turning gear operation of the turbine engine, which, as would be appreciated by those skilled in the art, presents substantially less severe operational conditions compared to on-line monitoring, which would be performed at relatively higher operating temperatures and pressures. It will be appreciated that a suitable cooling fluid (e.g., air) can be optionally passed through one or more conduits in the viewing probe to provide cooling to the electronic circuits therein (e.g., the linear array).

As may be appreciated in FIG. 2, linear array 22 may be positioned to extend along an axial direction 29 of the viewing probe 16, and may include an illumination source, such as one or more light emitting diodes 28 (LEDs) to illuminate the views of the passing rotating component. In one embodiment, LEDs 28 may be operated as a continuous illumination source, that is, continuously turned on while linear array 22 scans image data of the rotating component.

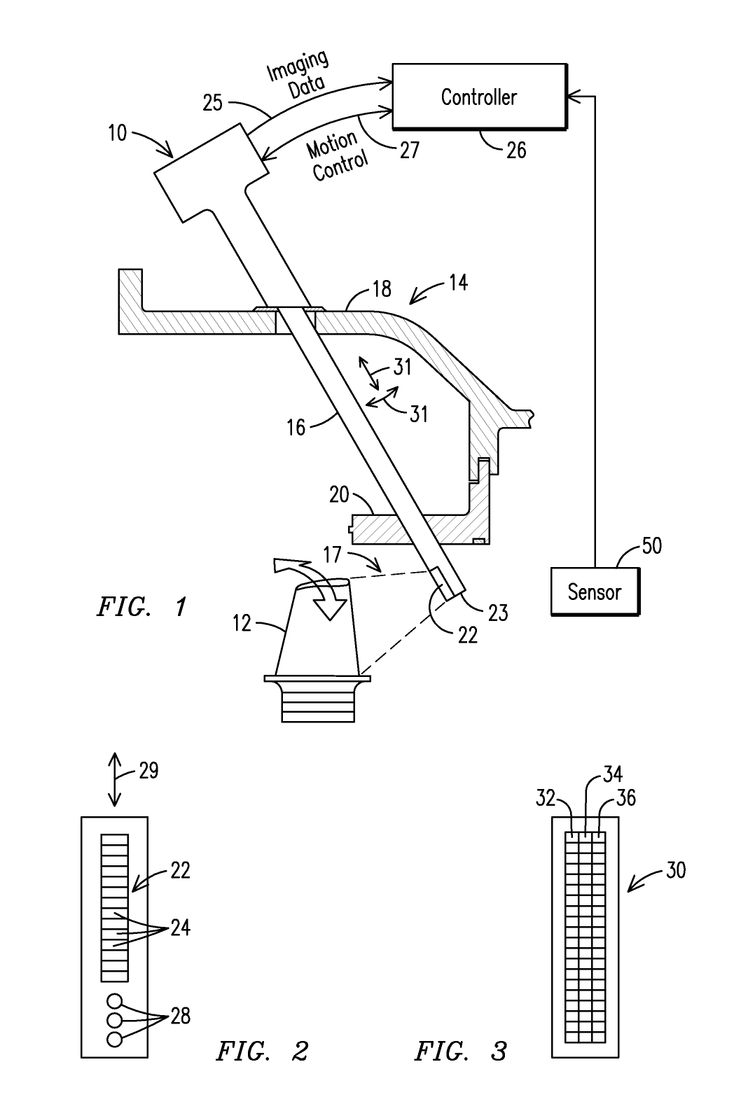

As may be appreciated in FIG. 3, in one non-limiting embodiment, the linear array of optical sensors may comprise a multi-linear array 30 of optical sensors, where each respective array of the multi-linear array may be arranged to sense a different wavelength such as a primary color so that the generated image comprises a color image of the component. For example, a first array 32 of multi-linear array 30 may sense a red color. A second array 34 of multi-linear array 30 may sense a green color and a third array 36 of multi-linear array 30 may sense a blue color (e.g., RGB primary colors).

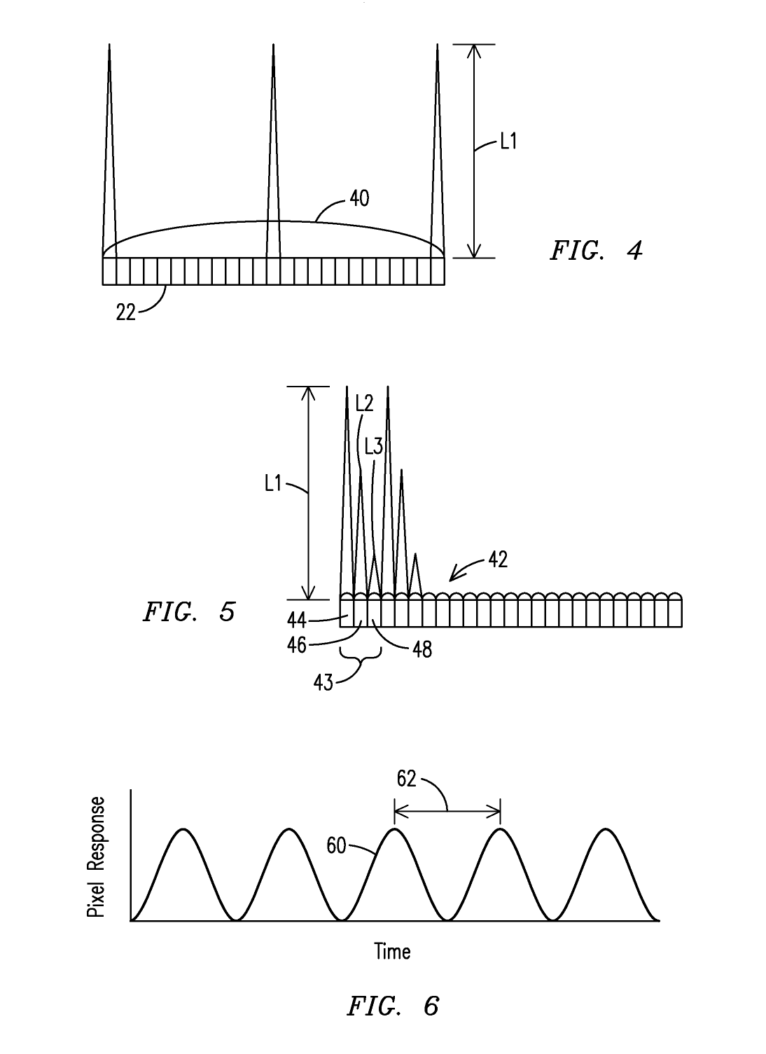

As shown in FIG. 4, in one non-limiting embodiment a lens 40 (e.g., a spherical lens having a predetermined focal length, such as at a distance L1) may be optically coupled to linear array 22. As shown in FIG. 5, in another non-limiting embodiment, one may use an array of microlenses 42, where each respective one of the microlenses may be optically coupled to a respective one of the optical sensors of the linear array. This may provide a more efficient optical coupling for each optically sensing pixel. In one embodiment, the array 42 of microlenses may be arranged to form groups of microlenses having different focal lengths. For example, as may be appreciated in FIG. 5, an example group 43 of microlenses may be made up of three microlenses, where a first microlens 44 may provide a focal length at a distance L1, a second microlens 46 may provide a focal length at a distance L2, and a third microlens 48 may provide a focal length at a distance L3. As will be appreciated by those skilled in the art, imaging data acquired by such grouping arrangements of microlenses can be processed to generate images of the rotating objects with a selectable focal view (e.g., selectable focus) after the image data is acquired. This would be analogous to the functionality of a light field camera (e.g., a plenoptic camera).

In one non-limiting embodiment, controller 26 may receive a once-per-revolution (OPR) pulse from a standard reference sensor 50 (FIG. 1). As will be appreciated by those skilled in the art, the OPR pulse may be used to measure rotational speed (or a period of rotation) of a rotating shaft where the blades may be mounted—from which respective delays (e.g., timing intervals) indicative of the position of the passing blades relative to the linear array may be estimated. The timing for triggering the series of line scans (e.g., scan rate) may be adjusted in response to a rotation rate of the component.

It will be appreciated that, in lieu of an OPR pulse, one may utilize respective signals from one or more sensors responsive to respective leading or trailing edges of the rotating blades to estimate the position of the passing blades relative to the linear array with a higher level of accuracy. This would provide relatively higher temporal resolution compared to the OPR pulse and may provide superior jitter control in the generated image. For example, the processing of the series of line scans may be configured to take into account variation in the rotation rate of the component.

FIG. 6 is a plot of an example waveform 60 that may be generated by an array of optical sensors embodying aspects of the present invention in response to passing blades. For example, when a passing blade is in the field of view of the linear array, then the amplitude response of the pixels from the linear array may be relatively higher (e.g., state of relatively high luminosity due to reflection from the passing blade) compared to periods when the passing blade is no longer in the field of view of the linear array (e.g., state of darkness). The inventor of the present invention has recognized that such a signal may be processed to estimate the position of the passing blades relative to the linear array. For example, a time interval 62 between adjacent peaks of the waveform may be used to estimate the position of the passing blades. This would allow eliminating the above-described sensor 50 responsive to the leading or trailing edges of the rotating blades.

While various embodiments of the present invention have been shown and described herein, it will be apparent that such embodiments are provided by way of example only. Numerous variations, changes and substitutions may be made without departing from the invention herein. Accordingly, it is intended that the invention be limited only by the spirit and scope of the appended claims.

The invention claimed is:

1. A gas turbine engine comprising:
at least one rotating component;
a viewing probe comprising a linear array of optical sensors disposed in the probe to acquire image data comprising a series of line scans capturing views of said at least one rotating component as the rotating component passes within a field of view of the probe; and
a controller electrically coupled to the linear array to process the series of line scans to generate an image of the component.

2. The gas turbine engine of claim 1, wherein the linear array extends along an axial direction of the probe.

3. The gas turbine engine of claim 1, wherein the linear array of optical sensors comprises a multi-linear array of optical sensors, each respective array of the multi-linear array arranged to sense a different primary color so that the generated image comprises a color image of the component.

4. The gas turbine engine of claim 1, further comprising an array of microlenses, wherein each one of the microlenses is optically coupled to a respective one of the optical sensors of the linear array.

5. The gas turbine engine of claim 4, wherein the array of microlenses comprise groups of microlenses having different focal lengths.

6. The gas turbine engine of claim 1, further comprising a lens optically coupled to the linear array of optical sensors.

7. The gas turbine engine of claim 1, wherein the linear array of optical sensors comprises an array of sensors selected from the group consisting of charge coupling device (CCD) sensors and complementary metal oxide semiconductor (CMOS) sensors.

8. The gas turbine engine of claim 1, wherein the viewing probe further comprises an illumination source to illuminate the passing rotating component.

9. The gas turbine engine of claim 8, wherein the illumination source comprises a continuous illumination source comprising at least one light emitting diode (LED).

10. An apparatus for a gas turbine engine comprising:
a viewing probe comprising a linear array of optical sensors disposed in the probe to acquire image data comprising a series of line scans capturing views of at least one rotating component of a gas turbine engine passing within a field of view of the probe; and
a controller electrically coupled to the linear array to process the series of line scans to generate an image of the component.

11. In a gas turbine engine, a method comprising:
disposing in a viewing probe a linear array of optical sensors;
acquiring with the linear array image data comprising a series of line scans capturing views of a passing rotating component of the gas turbine engine; and
processing the series of line scans to generate an image of the component in a controller electrically coupled to the linear array.

12. The method of claim 11, further comprising sensing a different primary color with a multi-linear array of optical sensors of the probe so that the generated image comprises a color image of the component.

13. The method of claim 11, processing a sensor signal to estimate a position of the passing component relative to the linear array.

14. The method of claim 13, further comprising using the linear array of optical sensors to supply the sensor signal.

15. The method of claim 14, further comprising adjusting a timing for triggering the series of line scans in response to the sensor signal.

16. The method of claim 11, wherein the processing of the series of line scans is configured to take into account variation in a rotation rate of the component.

17. The method of claim 11, optically coupling an array of microlenses to the linear array, wherein each respective one of the microlenses is optically coupled to a respective one of the optical sensors of the linear array.

18. The method of claim 17, arranging the array of microlenses to form groups of microlenses having different focal lengths.

19. The method of claim 18, wherein the image data comprises respective series of line scans capturing views having different focal views of the passing rotating component.

20. The method of claim 19, processing the respective series of line scans to generate an image having a view corresponding to a selected focal view of the different focal views.
